(19) United States
(12) Patent Application Publication
(10) Pub. No.: US 2008/0141796 A1
(43) Pub. Date: Jun. 19, 2008

(54) Apparatus and method for testing sprayability of a liquid composition

(76) Inventor: Lawrence Doka Gaultney, Elkton, MD (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/906,377

(22) Filed: Oct. 2, 2007

Related U.S. Application Data
(60) Provisional application No. 60/848,920, filed on Oct. 3, 2006.

(51) Int. Cl. G01M 19/00

(52) U.S. Cl. 73/866.4

(57) ABSTRACT

Disclosed is an apparatus and method for generating a reproducible and quantitative evaluation of the sprayability characteristics of a liquid composition. The apparatus enables continuous controlled circulation of a liquid composition through one or more filter screens with measurement of the pressure drop profile across each filter screen resulting in performance patterns characteristic of sprayability parameters, which can include speed, completeness of dispersion, and stability of dispersion.

### FIELD OF THE INVENTION

The present invention relates to an apparatus and method that enables evaluation of the sprayability of a liquid composition, particularly a crop protection product dispersed in water.

### BACKGROUND OF THE INVENTION

The commercial value of products in several industries depends on the effective mixing of a solid into a liquid or in the measurement of suspended solids in a liquid. Examples of such commercial products which entail such mixing or measurement include dispersible crop protection products, dietary and medicinal supplements, air fresheners and sanitizers, paints, and powdered drink mixes. It can also be important to evaluate the degree to which solids have precipitated out of a liquid, as in industrial waste control or cooling systems. Additionally, it can be useful to know the rate at which leak prevention additives will plug unwanted leaks, as in automobile radiators.

Liquid compositions that plug sprayer nozzles, filters, and/or screens ultimately lead to dissatisfied customers and lost sales. Customers have come to expect high quality water dispersible formulations as a “given” when they purchase crop protection products. Selling formulations that generate sprayability problems is undesirable.

The sprayability of a liquid composition can be a complex function of the product's dispersibility characteristics, water temperature, water quality, the nature of other products with which it has been mixed and/or time. Equipment and methods to evaluate liquid composition dispersibility are well known to those skilled in the art, but these methods are usually performed under conditions that do not match those of a spraying apparatus.

U.S. Pat. No. 4,347,742 describes an apparatus and processes for evaluating on a miniature scale the sprayability behavior of a specific sprayable aqueous composition. The apparatus and processes in the aforementioned patent provide the user with the capability to develop subjective and qualitative comparisons of the sprayability of test dispersions, which may be correlated with actual behavior in field equipment. Other methods and equipment have been developed which provide an evaluation of particulate and/or other solid contaminants in water, for example, those described in U.S. Pat. No. 6,248,243.

There is a need to develop an apparatus and a quantitative method for evaluating the sprayability of a liquid composition.

### SUMMARY OF THE INVENTION

This invention is directed to an apparatus for evaluating the sprayability of a liquid composition, comprising:
(a) a container having container inlet means for receiving a liquid composition and container outlet means for dispensing the liquid composition;
(b) a pump for circulating the liquid composition through the apparatus;
(c) a first means for providing fluid communication between the container and the pump;
(d) optional means for changing the temperature of the liquid composition;
(e) at least one flow conduit, said flow conduit being disposed downstream of and in fluid communication with a second fluid communication means, said flow conduit extending into the container, said second fluid communication means providing fluid communication between the pump and the flow conduit;
(f) optional means for dividing the flow of the liquid composition into at least two streams, said optional flow dividing means being disposed between the second fluid communication means and each of the flow conduits;
(g) means for filtering the liquid composition having a filter inlet means and a filter outlet means, said filtering means being disposed within each of the flow conduits, said filtering means having different filtering characteristics when more than one flow conduit is employed;
(h) first means for measuring pressure of the liquid composition in each flow conduit, said first pressure measuring means being disposed upstream of and in close proximity to the filter inlet means of the filtering means;
(i) second means for measuring pressure of the liquid composition in each flow conduit, said second pressure measuring means being disposed downstream of and in close proximity to the filter outlet means of the filtering means;
(j) means for restricting the flow of the liquid composition as it exits each flow conduit, said spraying means being disposed downstream of the second pressure measuring means; and
(k) optional means for reducing foaming of the liquid composition disposed downstream of the spraying means at or near a terminal end of each flow conduit.

This invention also relates to a method for evaluating the sprayability of a liquid composition, comprising:
(a) introducing a liquid composition into the apparatus of any of Claims 1-6;
(b) supplying power to the apparatus;
(c) circulating the liquid composition through the apparatus for a sufficient period of time;
(d) collecting pressure measurements from paired first and second pressure measuring means in each flow conduit at specified intervals during the time period;
(e) calculating the difference in pressure or percent of decrease in pressure of the liquid composition between each paired first and second pressure measuring means at each specified time internal;
(f) comparing data generated from the calculations; and
(g) optionally comparing the data with a compendium of previously obtained data, said data having been obtained using a common method protocol.

### BRIEF DESCRIPTION OF THE DRAWINGS

FIG. 1 is a depiction of one embodiment of a configuration for the apparatus of the present invention.

FIG. 2 is an expanded view of a filter screen assembly, one embodiment of a means for filtering included in an apparatus of the present invention.

FIGS. 3A, 3B and 3C are graphs which represent data collected by one embodiment of an apparatus of the present invention and which relate to percent of pressure drop as a function of time (seconds) for three different sized filter screens used in testing three different liquid compositions, as described in Examples 2, 3 and 4.

FIG. 4 is a three-dimensional matrix graph which shows the relative dispersibility performance (rate, completeness, and stability) of different liquid compositions tested in the Examples.

FIGS. 5A and 5B are graphs representing data collected by one embodiment of the present apparatus for the same liquid composition tested at two different times.

FIGS. 6A and 6B are graphs representing data collected by one embodiment of the present apparatus for the same liquid composition prepared at two different sites.

### DETAILED DESCRIPTION OF THE INVENTION

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The apparatus and methods of the present invention can provide a rapid, reproducible and quantitative evaluation of the sprayability of a liquid composition. As used herein the following terms shall have these definitions:

“liquid composition” generally refers to a liquid, which can include, for example water, a non-aqueous solvent, or the combination thereof, having particles dispersed, dissolved, suspended, slurried, and/or distributed therein resulting in a form which includes a solution, a dispersion, a suspension, a slurry, an emulsion or combinations of the foregoing.

“particle” means relatively small bits of a substance which may include solids, including powders, precipitates, granules or other agglomerates, liquid droplets or combinations of the foregoing.

“small bits” means particles of such a size that they may through normal handling of the liquid composition be evenly distributed throughout the liquid composition.

“granule” means a manufactured form made from solid agglomerated particles resulting in a mass, cluster or other specific form such as a sphere or cylinder. The granule upon contact with a liquid, usually water, and with agitation, separates into its component particles.

“agglomerate” means to bring together and bind particles, usually solid. Agglomeration may occur through intentional manufacture or through the unintentional coming together of particles which adhere to one other.

“non-aqueous” solvent means an organic liquid which may be miscible, immiscible or partially miscible with water.

“solution” means a homogeneous mixture of a liquid with other liquids or solids or combinations thereof resulting in a continuous liquid phase composition.

“dispersion” means a fluid composition in which the particles are distributed throughout.

“suspension” means a liquid composition in which solid particles larger than colloidal size are dispersed throughout the liquid phase.

“emulsion” means a liquid composition in which immiscible liquid particles of usually larger than colloidal size are dispersed throughout the main and different liquid phase.

“slurry” means insoluble solid particles dispersed throughout a liquid where the liquid is usually water and where the concentration of solids in the liquid composition may be high but not so high as to prevent pumping.

In one embodiment of the present invention, the liquid composition comprises one or more biologically active compounds or agents including herbicides, insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi. In other embodiments the liquid composition could comprise dietary and medicinal supplements, air fresheners and sanitizers, paints, and powdered drink mixes.

Reproducible, quantitative dynamic data can be generated for a liquid composition by using the apparatus and methods of the present invention to produce sprayability performance patterns. Such sprayability performance patterns can reflect one or more sprayability performance criteria associated with a liquid composition prepared and evaluated under a particular set of product and/or process condition variables. Such sprayability performance patterns can be used to assign ratings associated with a particular sprayability performance criteria. In addition, combinations of particular ratings of sprayability performance criteria can be used to assign a particular liquid composition to a sprayability performance category. A sprayability assessment protocol can be developed which comprises rules for evaluation conditions and rules for assignment of ratings for a particular type of liquid composition and thus provide reproducible, quantitative dynamic data for evaluations of that liquid composition.

One embodiment of the apparatus of the present invention may be used to evaluate the sprayability of a liquid composition intended for treatment of an agricultural crop. The apparatus is designed to pump the liquid composition in question through one or more filter screens under conditions very much like that found in actual farm spray equipment. The screens will provide resistance to flow in relation to how test materials disperse as part of the liquid composition. Data is recorded to reflect the pattern of flow resistance through all screens and may be used to rate the “sprayability” of the liquid composition.

A main feature of the apparatus is a container into which the liquid composition is introduced. The container may be made of plastic which is preferred to be clear so that the test liquid composition may be observed during the test. The material of construction of the container should be resistant to chemical attack by the test substances and should preferably remain clear for its useful life. The interior of the container should be smooth so that no buildup of material occurs during the test and its shape should be wider at the top and narrower at the bottom with sloping or vertical sides. The container need not withstand pressure greater than atmospheric, but it should be leakproof and should additionally be fitted with a top, which may be flat, and which has an opening through which the test liquid composition may be introduced for the start of the test and at least one other opening through which the test liquid composition may be returned during the test. The container may be custom manufactured or modified from available commercial containers. Suitable materials of construction include but are not limited to polypropylene, polyethylene and polyethylene terephthalate. The volume of the test container should be large enough to contain the full test liquid composition at a volume of 50 percent or less while the test is in process. The design of the narrow exit portion of the container should minimize vortexing of the test liquid as it exits the container. The test sample size should be the minimum which is practical in order to minimize waste. For agricultural spray dispersions, the minimum is about 500 millileters.

The narrow outlet of the container feeds into a pump which recirculates the liquid composition through a testing system, to be described later on, and then back into the test container. The pump should be of variable speed and capable of handling multi-phase test liquids at line pressures up to about 500 kPa. It should be of a type that can pump the liquid composition without becoming clogged and should minimally disrupt the degree of aggregation of any particulates within the liquid composition when they pass through its pumping chamber. A more continuous versus pulsing action pump is preferred. Positive displacement pump types are more suitable for this service than centrifugal pumps because of the grinding action of the latter. Several suitable designs include, but are not limited to, diaphragm pumps, piston pumps, peristaltic pumps, reciprocating pumps, plunger pumps, screw pumps and gear pumps. A diaphragm pump or a variation on this design is preferred. The materials of construction of the pump must resist chemical attack by the liquid composition.

A first means for fluid communication between the container and the pump may be provided in the form of tubing from the container outlet means to the pump inlet. A second means for fluid communication may also be provided in the form of tubing from the pump outlet to a means for dividing the flow into two or more flow conduits, each of which incorporates a different filtration means, a means for restricting the flow of the liquid composition and an optional means for reducing foaming of the liquid composition before it returns to the container. The tubing should have smooth internal surfaces and minimize retention of solids at points of connection and turns. The construction material for the first and second communication means, the flow conduits and the foam reduction device can include polymers and metals. Suitable polymers and products include, but are not limited to, polypropylene; polyethylene; polyvinylchloride; natural and synthetic rubber, such as neoprene and Norprene® polychlorprene; Tygon® silicone flexible tubing, Teflon® fluoropolymer, and nylon. If non-aqueous solvents are part of the liquid composition, a preferred construction material is Teflon® fluoropolymer. If the liquid composition contains water, then any of the other mentioned polymers will suffice. Suitable metals include, but are not limited to, easily fashioned corrosion-resistant metals, such as iron alloys which include chromium, nickel, or molybdenum and the like, e.g. stainless steels. The tubing diameter should be sized to provide an internal diameter that allows passage for the particulates in the liquid and allows a slightly turbulent flow for the liquid composition. A slightly turbulent flow can result when the velocity of the liquid composition through the apparatus is kept in the range of about 45 to about 60 cm/s. As an example, for a flow rate of about 2.2 L/minute, the tubing can have an inside diameter of about 8 to about 10 mm.

As mentioned above, the second fluid communication means may feed a means for dividing the flow into two or more streams each of which returns to the test container. The means for dividing the flow is constructed in such a way as to evenly distribute the flow from the second communication means so that an equal portion of the flow enters each exiting flow conduit. The means for dividing the flow should furthermore have smooth internal surfaces and provide no internal restriction or opportunity for solids accumulation. The internal diameter of the means for dividing the flow is preferred to be equal to that of the second fluid communication means. Depending on the number of exit flow conduits, the means for dividing the flow may be purchased as a standard fitting such a “tee” for two exit conduits. In the case of more than two exit conduits the means for dividing the flow may be custom made. A preferred material of construction is stainless steel. An additional optional outlet may be fashioned as part of the means for dividing the flow to which a means for measuring line pressure may be included.

Within each flow conduit there is disposed a means for filtering the fluid composition which may be in a variety of forms including but not limited to filter screens, perforated plates, or orifices. The purpose for the filtering means is to provide interaction with the test composition which closely simulates its behavior in commercial practice. For many applications, filter screens may be used. The filter screens are each placed perpendicular to the flow within its conduit so that the flow passes directly through it. The mesh size of each screen is preferred to be different from each of the other screen mesh sizes and of such particular size that may be relevant for the industry for which the test has been designed. For instance, in the agricultural crop protection industry typical screen sizes used in spray equipment includes mesh sizes of 75, 150 and 300 microns. Each screen should be contained in such a way as to resist leaking of the test composition and be made of a material resistant to chemical attack by the test composition. A preferred material of construction is stainless steel for the agricultural application, but other materials such as plastics and coated metals may be used, to name a few possibilities.

A means must be provided to evaluate the interaction of the filtration means with the test composition. A highly effective measurement is line pressure. Therefore, first and second pressure measuring means are positioned upstream and downstream of the filtering means, respectively. During test operation pumping rate is adjusted to maintain constant upstream line pressure. Even so, line pressure may occasionally change and it is therefore preferred to have pressure measurements both prior to and after the filtering means because it has been found that the fractional pressure change caused by each filtering means is a more useful indicator of fluid flow efficiency than is absolute pressure change. Both the first and second pressure measuring means are preferred to be placed as near to the upstream and downstream vicinities of the filtering means as practical and should be designed to reduce or eliminate any tendency of particulates to collect, settle, and/or accumulate in any fittings, which are included as part of the first and second pressure measuring means assemblies. Possible devices include both digital designs such as pressure transducers and digital gauges and analog designs such as mechanical gauges. It is preferred to have pressure measurements provided in electronic form and therefore digital devices are greatly preferred. Both direct and differential pressure measurement devices are available. Direct measurement devices are preferred because they provide a record of the input line pressure. Pressure measuring means can be constructed of materials that are resistant to attack or deterioration from the liquid composition that will be evaluated. Pressure measuring means should be selected with consideration of accuracy, precision and responsiveness with consideration given to the specific test requirements. For example, in the case of agricultural spray compositions a pressure transducer having a pressure measurement range of about 0 to about 690 kPa or about 0 to about 1035 kPA with a precision of about 0.1% of full scale may be suitable. Pressure transducers, for instance can generate electrical signals as voltage or as current, with current preferred.

Each flow conduit returns the liquid composition to the test container through a means for restricting its flow. In the case of agricultural spray compositions the restriction means may be selected in the form of a conventional spray nozzle since that is precisely how such compositions are delivered to a crop in the field. The spray nozzle should be positioned above the surface of the liquid level in the test container to serve the purpose that the spray pattern of the liquid composition may be observed during the test. A more general purpose for each nozzle is to restrict the liquid composition flow during the test so that the desired upstream line pressure may be maintained. Other possible means for restricting the flow may include but are not limited to an orifice plate or a crimped tube.

The return of liquid composition through the flow restriction means above the liquid surface will likely increase the turbulence in the test container. Therefore a means for reducing the foaming potential of the liquid composition may optionally be included. This foam reduction must be accomplished without addition of any new material into the test. Possible approaches include a plate against which the spray may impinge or preferably, a tube extending below the liquid surface within which the spray may be collected and settled. The tube, which may be attached directly around the spray nozzle, should be clear to allow observation of the spray, and constructed of a material which is resistant to attack by the liquid composition. Any of the plastic materials mentioned above may be suitable. The tube internal diameter must not further restrict the flow of the liquid composition.

Because test temperature may affect test results and spray compositions must be applied in the field, over a wide range of temperatures, it is useful to include an optional means for changing the temperature of the liquid composition. Most standard tests are preferred to be run at an intermediate temperature such as 20-25° C. (68-77° F.) since that temperature can easily be accomplished under normal laboratory conditions. If the temperature of the circulating liquid composition is to be changed then it is necessary to size the means for changing the temperature such that it maintains the liquid composition at the desired temperature for the duration of the test. In the case the temperature is to be reduced, then a simple heat exchange arrangement may be preferred. This may take the shape of a coil with the same internal diameter as the first and second means for fluid communication which is placed in the line between the pump and the flow dividing means. The material of construction of the coil should be one which is both resistant to the liquid composition and is also a good conductor of heat. Stainless steels are preferred. The coil may pass through a chamber or be immersed in a bath which contains another material maintained slightly below the desired temperature at which the test is to be run. The test liquid composition is passed through the coil and is cooled to the desired test temperature. The chamber through which the coil passes may be a simple container filled with ice water. The chamber may be made from polymers or metals, including but not limited to polypropylene, polyethylene, polyethylene terephthalate, and stainless steels. If the liquid composition is to be heated, then is may be preferable to use electrical heating to maintain the liquid in the chamber above room temperature. In such case the preferred material of construction is stainless steel.

Applications for the test apparatus include, but are not limited to, circumstances for observing the timing and intensity of buildup of substances in the test liquid composition which may impede the fluid flow leading to pluggage of the filtration, means or observing timing and intensity of dispersion of materials in test compositions, which flow more easily through the filtration means. A third application would be to observe the rate at which a leak may be plugged, in which case the filtration means will be the site of desirable plug formation. In the first two of the above three cases the desired condition occurs when the filtration means either never becomes blocked or in which a blockage disappears with time. In these first two cases the liquid composition passes through the filtration means, without any discernable pressure drop. In the third case there is no pressure drop through the filtration means but as the filtration means becomes more constricted, the pressure drop should increase. In all three cases above, the test apparatus is best designed to run at a constant pressure upstream of the filtration means so that any observable pressure drop through the filtration means will be due to changes at the filtration means and not due to changes in upstream pressure. For the case of the apparatus specifically designed for testing agricultural test liquid compositions the upstream pressure may be maintained constant through the use of identical spray nozzles as means for restricting the flow of the test liquid as it exits the filtration means. The spray nozzles and pump are chosen, so that the flow conditions in the circulation lines described before are met; that is, so that a slightly turbulent flow condition is maintained when the flow velocity is kept on the range of about 45-60 cm/sec.

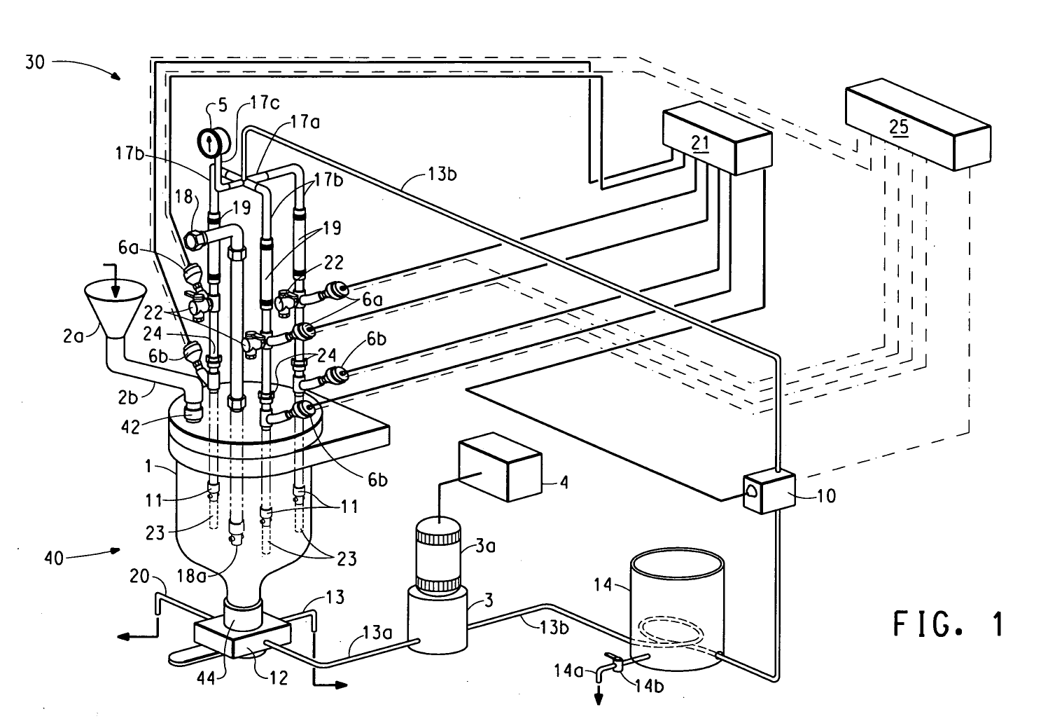

FIG. 1 shows a system of the present invention for evaluation of the sprayability of a liquid composition designated in its entirety as 30. System 30 comprises an apparatus 40, a power supply 21, and a means for computing 25. System 30 can optionally further comprise a frame (not shown) for supporting apparatus 40.

Apparatus 40 comprises container 1 for receiving, holding and/or dispensing a liquid composition, said container having container inlet means 42 and container outlet means 44. Container inlet means 42 facilitates receiving the liquid composition into container 1. Through container outlet means 44 the liquid composition is dispensed from container 1 and thus container outlet means 44 facilitates circulation of the liquid composition through first fluid communication means, shown in FIG. 1 as first circulation line 13a, to pump 3, and/or draining of the liquid composition from container 1 through drain tube 20. Container 1 should be of sufficient volume to contain the fluid volume while maintaining spray nozzle 11 above the top level of the liquid composition. In this embodiment, container 1 is vented to the atmosphere through container inlet means 42 in order to prevent the buildup of pressure within the interior of container 1. Container inlet means 42 is disposed at or near the upper region of container 1. The liquid composition to be evaluated can be introduced into container 1 through container inlet means 42 by first pouring the liquid composition through funnel 2a whereby it passes through feed line 2b which interconnects with container inlet means 42. In this embodiment, funnel 2a and feed line 2b have matching internal diameters large enough to allow rapid introduction of the liquid composition into container 1. Container outlet means 44 is disposed at a lower region of container 1. Liquid composition to be evaluated exits container 1 through container outlet means 44 which interconnects with first fluid communication means, shown in FIG. 1 as first circulation line 13a. Liquid composition can be drained from container 1 through container outlet means 44 to which can be connected means for draining which is shown in FIG. 1 as drain tube 20. Exit of liquid composition from container 1 can be controlled by a valve, for example, container exit valve 12, as shown in FIG. 1. Container exit valve 12 can be set in three positions: (1) for circulation of the liquid composition, container exit valve 12 is positioned to allow the liquid composition to flow into first circulation line 13a; (2) for draining of the liquid composition from container 1, container exit valve 12 is positioned to allow the liquid composition to flow through outlet means 44 into drain tube 20, and (3) for draining container 1 of any rinse liquid through rinse line 13. In addition, for cleaning purposes, container exit valve 12 can allow the contents of container 1 to exit through rinse-out line 13. This embodiment of container exit valve 12 is a three-way ball valve design made of stainless steel which is resistant to corrosion by the liquid composition and capable of providing an unobstructed flow of the liquid composition. Funnel 2a and feed line 2b may be made from polyvinyl chloride. As shown in FIG. 1 an inverted clear polymeric bottle with its narrow end modified to mate with the container exit valve 12 can be utilized to serve as container 1. In this embodiment a polyethylene terephthalate soda bottle has been adapted for this purpose.

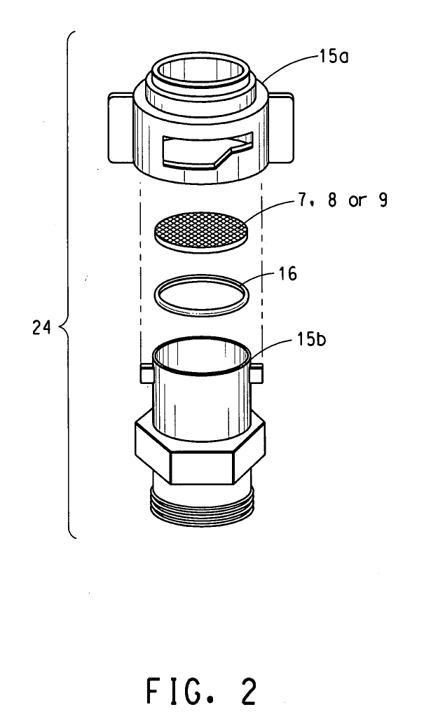

Pump 3 circulates the liquid composition received from first circulation line 13a by pumping it through apparatus 40. Pump 3 was sized to deliver a constant flow and pressure as the liquid composition passes through screen(s) 7, 8 and/or 9 (see FIG. 2). Pump 3 is rotated by electric motor 3a. The speed of pump 3 is controlled by varying voltage, thereby eliminating the need for a bypass circuit for excess flow. Pump 3 is shown as connected to pump power supply 4.

First circulation line 13a interconnects container 1 and pump 3 and provides passage for the liquid composition. Second means for fluid communication, shown in FIG. 1 as second circulation line 13b interconnects pump 3 and means for dividing flow of the liquid composition, shown in FIG. 1 as flow divider 17a. Both first circulation line 13a and second circulation line 13b are constructed of smooth-walled stainless steel tubing of which is corrosion proof and easily capable of withstanding pressure up to about 300 kPa without leaking.

Apparatus 40 of the embodiment shown in FIG. 1 comprises temperature changing reservoir 14. Temperature changing reservoir 14 is made of stainless steel. Temperature changing reservoir 14 has been fitted with means to drain its contents, such as water and melted ice therefrom, shown in FIG. 1 as temperature changing reservoir drain line 14a and temperature changing reservoir drain line valve 14b. Second circulation line 13b is shown coiled within temperature changing reservoir 14 to enable the temperature of the liquid to be lowered. The number of coils depends on how much cooling is needed for a particular liquid composition. Heating of the liquid composition within second circulation line 13b could have been similarly provided by subjecting second circulation line 13b to a source of heat provided by, for example, an electrical heating coil or heat transfer jacket. Temperature changing reservoir 14 if used for heating a liquid composition would be constructed of stainless steel or heat resistant glass, for accommodating, for example, heated water.

Second circulation line 13b interconnects pump 3, temperature changing reservoir 14, flow meter 10, and flow divider 17a.

Flow dividing means, shown as flow divider 17a in FIG. 1, separates the liquid composition into three streams each of which flow through flow conduits 17b. An optional pressure measuring conduit designated 17c is also provided which terminates with pressure gauge 5. Pressure measuring conduit 17c leading to pressure gauge 5 is designed to prevent particulates in the liquid composition from reaching pressure gauge 5. Flow divider 17a and flow conduits 17b and pressure measuring conduit 17c can be designed of a corrosion-resistant material, such as stainless steels and iron alloys which include chromium, nickel, or molybdenum and the like. In embodiment shown in FIG. 1, the internal diameter of flow divider 17a and flow conduits 17b and pressure measuring conduit 17c are of equal size to provide an equal propensity for flow of the liquid composition throughout. The size of the internal passages within flow divider 17a and flow conduits 17b and pressure measuring conduit 17c are approximately equal to the internal diameter of second circulation line 13b. Any transition fittings included with flow divider 17a are rounded to prevent the accumulation of particulates. In this embodiment few or no cavities or interstices exist within flow divider 17a, flow conduits 17b and pressure measuring conduit 17c, first circulation line 13a and second circulation line 13b wherein particulates could settle out or collect. The material of construction of the aforementioned elements (13a, 13b, 17a, 17b, 17c) is preferably stainless steel. Disposed within flow conduits 17b are means for filtering, shown as filter screen assembly 24 and transparent sight section 19 which permits visual inspection of the liquid composition. Transparent sight section 19 can be made from glass, or polymeric tubing such as but not limited to Tygon® flexible tubing, polyethylene, Teflon® fluoropolymer, polyvinylchloride or other clear polymeric materials.

Means for filtering the liquid composition is disposed within the three flow conduits 17b. As shown in the embodiment of FIGS. 1 and 2, the filtering means are provided by filter screen assembly 24. Filter screen assembly 24 has a filter inlet means shown as top screen assembly 15a, and a filter outlet means shown as bottom screen assembly 15b. Between top screen assembly 15a and bottom screen assembly 15b resides screen 7, 8, or 9, and screen gasket 16. In each filter screen assembly 24, screen 7, 8 or 9 is enclosed by screen gasket 16 which sits snugly on top of bottom screen assembly 15b. Top screen assembly 15a has grooves within its body which mate with a set of extensions on bottom screen assembly 15b. When mated and twisted counter to each other, top screen assembly 15a and bottom screen assembly 15b are pulled closer to each other by the graduated groove in top screen assembly 15a and become sealed against screen gasket 16. This tightly assembled filter screen assembly 24 is leak-proof. One screen filter assembly 24 is disposed within each flow conduit 17b wherein the screen openings of screen 7, 8 or 9, as the case may be, face perpendicular to the flow of the liquid composition thus permitting the liquid composition within each flow conduit 17b to pass directly through screen 7, 8 or 9. Screens 7, 8 and 9 can have been selected to reflect the sizes and types of screen that will be used to spray the liquid composition in non-evaluation conditions. For example, screens having opening spaces of 300, 150 and 75 microns in width (also described as 50 mesh, 100 mesh and 200 mesh) are used in commercial agricultural sprayers and such screens is used in filter screen assembly 24 wherein screen 7 is 50 mesh (having the widest of opening spaces), screen 8 is 100 mesh and screen 9 is 200 mesh (having the smallest of opening spaces). In the embodiment shown in FIG. 2 screens used in the present invention are made of stainless steel, a non-corrosive material. These non-corrosive screens have been designed to be easy to remove, inspect, and clean.

First means for measuring pressure of the liquid composition as it flows through each flow conduit 17b, is shown in FIG. 1 as pressure transducer 6a. Pressure transducer 6a is disposed along flow conduit 17b between flow divider 17a and filter screen assembly 24 upstream of and in close proximity to top filter assembly 15a in order to obtain a pressure reading close to what the pressure of the liquid composition is as it enters filter screen assembly 24. Second means for measuring pressure of the liquid composition as it flows through each flow conduit 17b is shown in FIG. 1 as pressure transducer 6b. Pressure transducer 6b is disposed downstream of, and in close proximity to, bottom filter assembly 15b in order to obtain a reading of the liquid composition immediately after filtering. Pressure transducers 6a and 6b internals are constructed of stainless steel and the external casings of stainless steel and Valox® polyester resin. Pressure transducers 6a and 6b are positioned at an angle of about 45 degrees with respect to the direction of flow of the liquid composition to reduce or eliminate any tendency of particulates to collect, settle, and/or accumulate in any fittings. Pressure transducers 6a and 6b have been selected with consideration of both accuracy and precision. For example, a pressure transducer having a pressure measurement range of about 0 to about 690 kPa or about 0 to about 1035 kPA with a precision of about 0.1% of full scale can be suitable. Pressure transducers 6a and 6b can generate an electrical signal as a voltage or as current, with current preferred.

System 30 further comprises power supply 21 and the appropriate cable and/or wire connections to provide DC power to transducers 6a and 6b and flow meter 10.

System 30 further comprises a data collection device, not shown, which converts the analog electrical signals from flow meter 10 and pressure transducers 6a and 6b into digitized output and then into data that can be collected and stored and used for computing a difference in pressure or a percent of decrease in pressure based on data generated by paired pressure transducer 6a and pressure transducer 6b from each flow stream. As shown in FIG. 1, computer 25 can be used for the computations. Software associated with the data collection device can be installed on computer 25. Suitable devices include Model SC-2345 Data Collection Device or DAQCard-6036E both from National Instruments Corporation. The computer should be capable of collecting and storing data in real time with a frequency commensurate with the object of a particular study.

The apparatus of the present invention can also comprise means for restricting the flow of the liquid composition as it exits each flow conduit 17b. Such flow restriction means is shown in FIG. 1 as spray nozzle 11 which is disposed downstream of pressure transducer 6b. Spray nozzle 11 is selected to control the flow of the liquid composition through pump 3 at a given operating pressure and flow rate. Spray nozzle 11 can be selected from nozzle types customarily used to apply the liquid composition being evaluated to observe if undue nozzle corrosion or wear occurs during testing regimes. In evaluations where multiple nozzles are used simultaneously, as with the embodiment in FIG. 1, all nozzles are of the same type and size. As an example a nozzle that yields a liquid flow rate of about 0.8 to about 1.1 L/minute at a line pressure of about 275 kPa can be used. A variety of nozzle designs are suitable, including those which provide the above combination of flow rate and pressure.

The liquid composition flows equally and separately through each of the flow conduits 17b passing through filter screen assembly 24 and exiting through spray nozzles 11. Foam reduction tubes 23 can be provided which introduce the fully recombined stream to container 1 beneath the surface of the liquid composition residing in container 1 without undue turbulence thereby minimizing creation of foam in container 1. The foam reduction tubes provide an air space between the spray nozzle exits and the surface of the liquid. The sprayed material then has a chance to collect and settle. If the spray were permitted to enter the liquid directly it would be more likely to cause turbulence and with it, foam. Foam reduction tube 23 can be transparent and can be made from flexible tubing. Suitable materials for foam reduction tube 23 include but are not limited to Tygon® flexible tubing, polyethylene, Teflon® fluoropolymer, polyvinylchloride or other clear polymeric materials.

FIG. 1 also shows several convenient elements for cleaning apparatus 40 between tests. Temperature changing reservoir 14 is provided with temperature changing reservoir drain line 14a and associated temperature changing reservoir drain line valve 14b so temperature changing reservoir 14 can be emptied. Container 1 is provided with rinse supply line 18 through which water or another suitable rinse fluid can be introduced. Rinse supply line 18 can be outfitted with a quick connect/disconnect fitting on its inlet and a spinning cleanout nozzle 18a on its outlet so that cleaning fluid can be vigorously distributed throughout container 1. The cleaning fluid can be pumped throughout apparatus 40 to clean all the apparatus lines including circulation lines 13a and 13b, flow divider 17a and flow conduits 17b and pressure measuring conduit 17c. Filter line air bleed valves 22 are provided so that any liquid composition trapped along flow paths above container 1 can be drained. Waste drain line 20 enables the spent liquid composition to be drained from container 1 and properly disposed of. Rinsate drain line 13 is also shown. Container exit valve 12 can be set to direct liquid composition within container 1 through either of these two lines.

Particular embodiments of the present apparatus as indicated in the detailed description of the invention above, include:

Embodiment A: The apparatus described above wherein the flow dividing means comprises a flow divider which separates the liquid composition into three streams.

Embodiment B: The apparatus of Embodiment A wherein each of the filtering means comprises a screen with a different mesh size.

Embodiment C: The apparatus described above wherein both the first and second pressure measuring means comprises a pressure transducer with requisite accuracy and precision.

Embodiment D: The apparatus described above wherein the temperature changing means is present and lowers the temperature of the liquid composition.

The apparatus and methods of the present invention as described in the above embodiments enable quantitative and reproducible assessment of the sprayability performance of liquid compositions comprising biologically active particulates which are used in the production of agricultural crops. Different product variables and/or different process condition variables can be integrated into a sprayability evaluation. For reproducibility and standardization however it is necessary to use the same product variables and/or same process condition variables for all test samples for a particular evaluation. Repeatability from test to test is necessary for certain sprayability evaluations. For these types of evaluations, the sprayability performance patterns from two test runs using identical liquid compositions prepared and run under identical process conditions should be so nearly indistinguishable from each other that they produce the same performance ratings in all selected protocol performance categories. For other comparisons and diagnosis of certain problems, changing a product or process condition variable can be useful and can result in differing sprayability performance patterns. A sprayability assessment protocol can be developed and used to govern sprayability evaluations, providing rules for product variables and process conditions and rules for the assignment of ratings.

Product variables that can be considered during preparation of a liquid composition to be evaluated can include, but are not limited to, one or more of the following depending on the purpose of the sprayability evaluation: type of liquid, e.g. aqueous or organic; liquid quality, e.g., amount and/or type of mineral content; temperature of the liquid and/or liquid composition, e.g., cold or warm, such as about 0° C. or about 20° C.; total liquid volume which, for example, can include a range between about one-half and about two-thirds the volume of the container of the present apparatus; type of particulate, e.g., specific compound; form of particulates; amount of particulates to be contacted with the liquid during preparation of the liquid composition; ratio of particulates to liquid which can be chosen to be more concentrated than typically used to intensify possible negative effects; means for agitating and/or mixing the particulates and the liquid, e.g., a mixer; mixing rate; duration of mixing; properties of other tank mixture ingredients, including solid or liquid, pH, etc.); and type of vessel for holding the liquid composition prior to being fed into the container of the present apparatus. Other product variables can be based on whether or not the liquid composition has been designed for control of insects, plant disease or weeds.

In a sprayability evaluation for a particular water-dispersible crop protection product, for example, a prescribed amount of crop protection product, e.g., 20 g, can be dispersed into 500 mL of distilled water in a mixer, the distilled water having a volume about two-thirds the volume of the container of the present apparatus, and agitated at a rate of 200 rpm for two minutes immediately prior to its introduction into test container 1.

Total test circulation time can be varied and can be chosen based on the purpose of the evaluation and/or the nature of the information desired. Evaluations using the present apparatus and methods can thus be conducted using a batch or a continuous mode, with continuous being preferred. Thus, the batch embodiment of test time is the time required for a liquid composition to make one complete pass through the present apparatus. In a continuous mode, two or more complete passes through the present apparatus can be made, or longer test times can be chosen based on the amount of information desired to characterize the sprayability performance of a particular liquid composition and/or to meaningfully compare one liquid composition with another. Test lengths can generally range from about 15 seconds to about 30 minutes, but can include shorter or longer times.

Pressure readings are collected at specified intervals during the test, which intervals are preferred to be all the same length. A reading from the flow meter can also be collected at intervals coincident with those of the pressure transducers.

Other process condition variables used during the sprayability evaluation can include but are not limited to circulation time before spraying; pump circulation flow rate, line pressure immediately prior to the first three pressure transducers, e.g. about 138 to about 276 kPA.

The present invention concerns a method for evaluating the sprayability of a liquid composition, comprising: (a) supplying power to the apparatus (b) preparing a liquid composition by premixing a sample of selected size into water for a given time and at a given agitation rate; (c) introducing the prepared liquid composition into the apparatus of the present invention; (d) circulating the liquid composition through the apparatus for a sufficient period of time; (e) collecting pressure measurements from paired first and second pressure measuring means at specified intervals during the period of time; (f) calculating the difference in pressure or percent of decrease in pressure of the liquid composition between each paired first and second pressure measuring means at each specified time internal; (g) comparing data generated from the calculations for each flow path; and (h) optionally comparing the data with a compendium of previously obtained data.

Embodiments of the present method include the embodiments described above for the present apparatus and further include:

Embodiment 1: The method described above wherein the specified interval ranges from 1 to 5 s (seconds).

Embodiment 2: The method described above wherein the data is graphed to show the percent of pressure drop in each flow conduit over time.

Embodiment 3: The method described above wherein the liquid is water and the composition comprises a biologically active compound or agent which is dispersible or soluble in water.

With reference to FIGS. 1 and 2, the liquid composition is introduced into container 1 by pouring it through funnel 2a whereby it flows through feed line 2b which is in fluid communication with inlet means 42. Simultaneously, pump 3 is supplied with power via pump power supply 4. These actions occur at test time zero. The diameter of inlet means 42 is preferably large enough to enable the liquid composition to enter container 1 without significant time delay, for example about 1 to about 2 s. Pump 3 begins to circulate the liquid composition through first circulation line 13a. The pump control can be set to a desired operating pressure, for example between about 35 and about 415 kPa. The liquid composition passes through first circulation line 13a to pump 3. The liquid composition exits pump 3 and enters second circulation line 13b, passes through temperature changing reservoir 14, which may or may not lower the temperature of the liquid composition depending on the parameters of the evaluation, and flow meter 10 and travels to flow divider 17a where it is split into four streams, three of the streams flow into flow conduits designated 17b and one streams flows into flow conduit designated 17c which terminates in pressure gauge 5. The liquid composition travels in parallel through each flow conduit 17b, past pressure transducer 6a, through the filter screen assembly 24, past pressure transducer 6b, through spray nozzle 11, and through foam reduction tube 23, where it again is collected in container 1 and continues to circulate throughout apparatus 40 for as long as desired.

The number of screens used and the size of the individual screen openings within each screen can be chosen based on conditions that most closely simulate actual equipment and operating conditions. For evaluation of crop protection products, one embodiment is to use three screens with individual screen openings of 300, 150 and 75 microns respectively. Pressure buildup an d release across each screen can differ and thus provides unique information about the sprayability of a particular liquid composition.

In the embodiment shown in FIG. 1, seven data readings can be collected and/or recorded at specified predetermined time intervals for the duration of a sprayability evaluation; one flow reading collected from flow meter 10 and six pressure readings collected from pressure transducers 6a and 6b. As an example, for measuring typical dispersion times of granular agricultural products, a data collection interval of about 1 to about 5 s can be used. The paired pressure readings from the pressure transducers 6a and 6b located along the same flow conduit 17b can be used to measure the difference in pressure or the pressure drop across screen 7, 8, or 9 within the same flow conduit 17b and in one embodiment are taken simultaneously. This simultaneous difference between the pressure at first pressure transducer 6a and second pressure transducer 6b in each flow conduit 17b is simply calculated by subtracting the one pressure reading from the other. In order to calculate the percent of decrease in pressure, the difference in pressure readings is divided by the actual pressure at first pressure transducer 6a to arrive at the percentage pressure drop across screen 7, 8 or 9.

After collecting data from an evaluation test run, such data can be presented in various forms for examination and evaluation. The data can be stored and/or compared, such as by plotting graphically or by calculating pressure changes and rates of change for each of the filters, to reveal the behavior of the liquid composition over time as it passes through each filter screen assembly 24. An algorithm can be developed as experience with the data is developed that enables a more direct evaluation for the sprayability of a particular liquid composition. The percentage pressure drop across each screen 7, 8 or 9 is indicative of the size and number of particulates found in the liquid composition. For example, a finely dispersed product will cause little or no increase in pressure drop across varying sized filter screens if all of the flow passages in each screen remain open. A poorly dispersed product can cause varying degrees of blockage in one or more varying sized filter screens thereby creating a measurable increase in pressure drop across one or more of these screens. Normally, a finer screen will begin to collect particles and become wholly or partially blocked more rapidly than would a coarser screen.

In combination, the pressure drop profile for the number and types of screens used in a particular evaluation provides a unique and reproducible quantitative pattern indicative of the sprayability of the liquid composition. Examination of a sprayability performance pattern recorded as a graph (or other evaluation means) and comparing the sprayability performance pattern to a sprayability performance pattern generated in an evaluation for the same, similar or different liquid composition under the same, similar, or different conditions can assist in the evaluation of the sprayability of a liquid composition. Depending on the complexity of performance standards for a particular test in a specific industry, one or more different screens may be required. As, for instance with drink mixes, if a particular test were to measure how well a powder dissolved in water, then only one screen might be required and a performance pattern for only the rate of dissolution may need to be generated. Alternatively, the assessment for sprayability performance for an agricultural product dispersed in water delivered through a spray boom has been found to require more than one screen, with three being preferred. Because performance standards for different agricultural product types differ, many combinations of pressure drop through the different screens are required. Because test results must also be reproducible it is essential that data be taken frequently enough to capture critical changes in pressure drop performance across any screen. For instance, initial pressure drop across a plugged screen will be high, but if the material at the screen becomes more dispersed or dissolved in the flowing water stream, pressure drop will decrease with time. The pattern of pressure drop changes for each screen will be the basis for evaluating product performance characteristics. Changes such as these may occur within a second or two and data capture must be frequent enough to record such a change. In addition, data detection devices; in this case the pressure transducers, must generate data with the requisite accuracy, precision and speed to make clear the aforementioned changes. Also the form of the data is preferred to be electronic and should be transformed for direct capture to a data collection system, such as a spreadsheet.

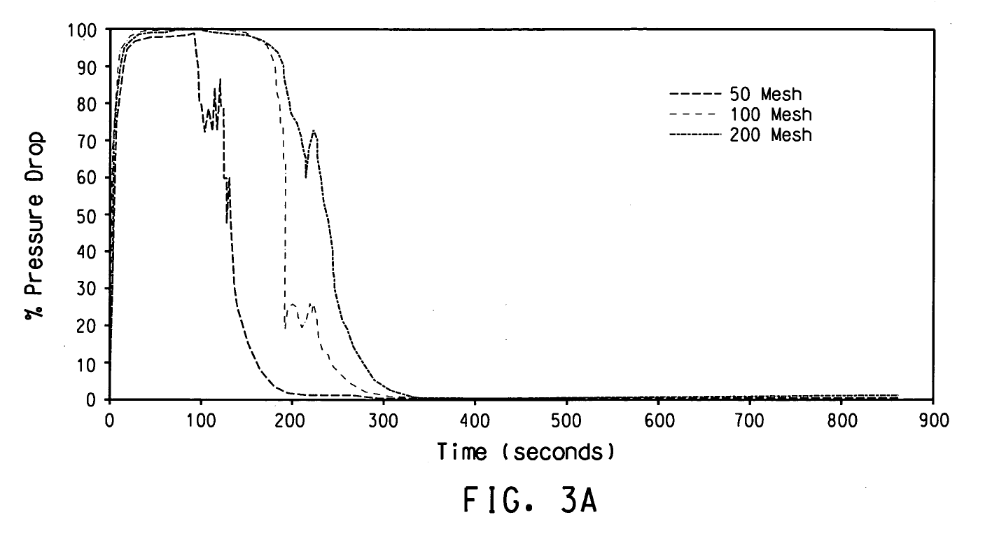

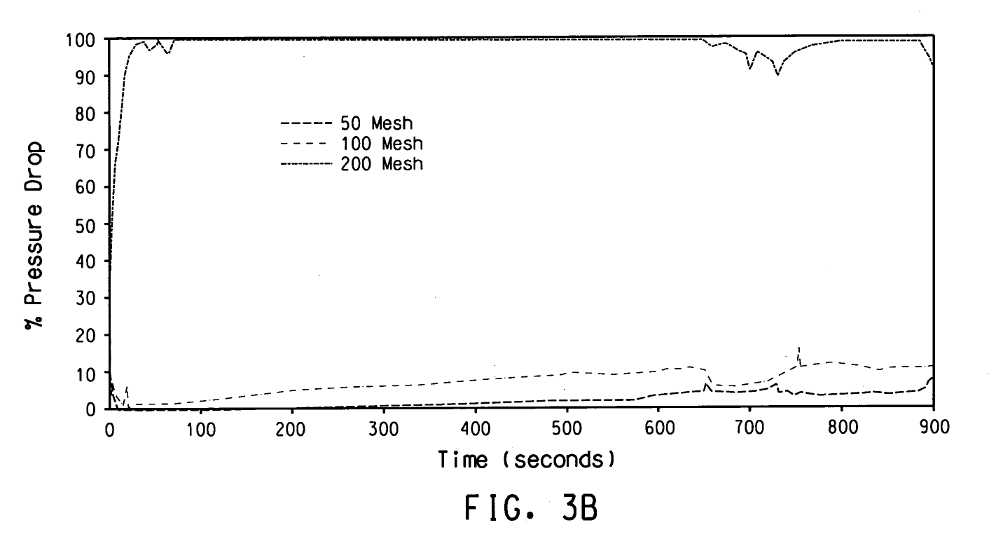

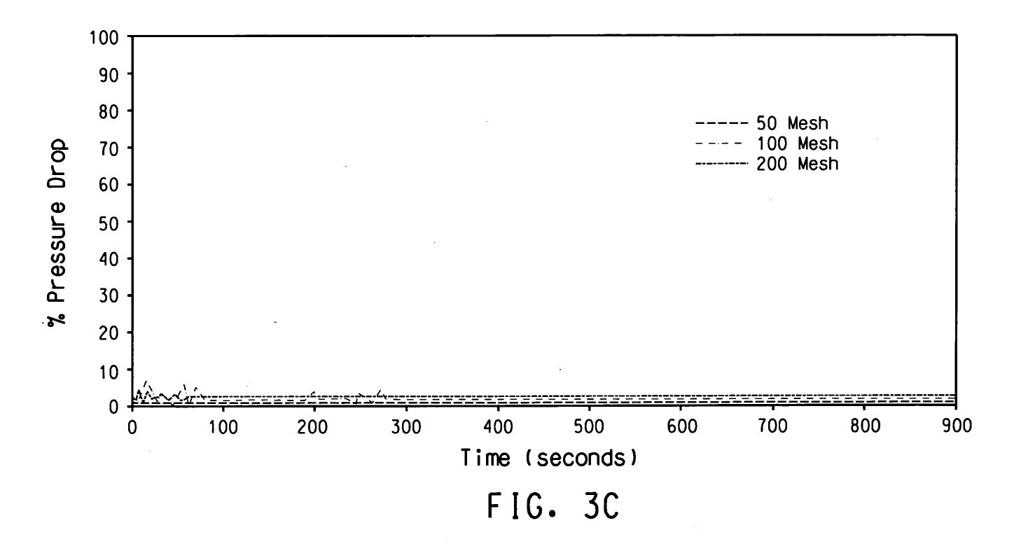

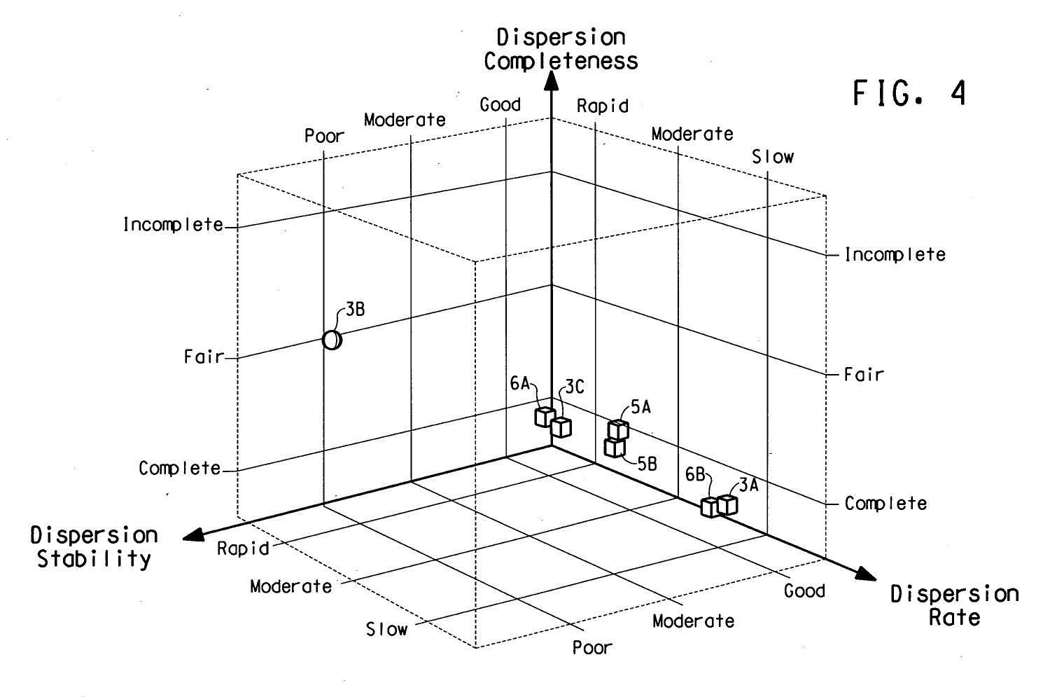

Sprayability performance patterns in the form of graphs constructed using data generated during evaluations using the present apparatus and methods and described in Examples 2, 3, 4, 5 and 6 are shown in FIGS. 3A, 3B, 3C, 4, 5A, 5B, 6A and 6B. The three curved lines on each graph in FIGS. 3A, 3B, 3C, 5A, 5B, 6A and 6B show the percent of pressure drop in each flow conduit 17b containing a filter caused by the pressure drop across the filter in that flow conduit. The results from a 300, 150 and 75 micron filter are shown in these graphs. FIG. 4 is a three-dimensional matrix graph which uses the data represented in the other figures to present a relative categorization of each liquid composition tested based on dispersibility as the sprayability performance criteria, and rates dispersibility results on rate, completeness and stability.

Sprayability performance patterns such as those shown in the graphs of FIGS. 3A, 3B and 3C enable assessment of sprayability performance based on sprayability performance criteria which include, but are not limited to, rate of dispersion or solution; or speed with which particulates break into finer particulates in a liquid; or rate or speed at which particulates dissolve and become distributed in a liquid; quality of liquid composition, or the completeness with which particulates disperse or dissolve; stability of a liquid composition over time, or the tendency of particulates to precipitate out or reagglomerate; amount of filter blockage; amount of nozzle blockage; amount of foaming in a tank; amount of product settling in a tank; and type of sprayer cleanout problems.

Using the apparatus and methods of this invention, it is possible to produce a compendium of reproducible quantitative sprayability performance patterns, each indicative of the sprayability performance of an associated liquid composition subject to particular product and process condition variables. Such a compendium along with an interpretive methodology can be useful as a statistically relevant reference. Because the sprayability performance patterns can be produced using standard test conditions, they can be directly comparable. An examination of FIGS. 3A, 3B and 3C show three very different performance patterns. FIG. 3A for instance, shows that all three screens are plugged at the start of the test but then for each the pressure drop reduces quickly but at different times. The pressure transducers and data capture system must be accurate and responsive enough to reproduce the positions and approximate timing for the pressure reductions across each screen.

Additional information concerning sprayability performance of a particular liquid composition is also available when sprayability performance patterns are collected for the same liquid composition under different process conditions or by varying the make-up of the liquid composition and testing it under the same process conditions. A compendium of sprayability performance patterns can be updated as data from additional evaluations is made available and can be compared with knowledge obtained from actual field performance.

An examination of FIGS. 3A and 3B shows that the sprayability performance patterns differ and thus the sprayability performance differs for the two liquid compositions tested based on a difference in one or more sprayability performance criteria. Relative sprayability performance ratings for sprayability performance criteria can be developed based on sprayability performance patterns generated and associated with the sprayability performance criteria. Representative examples of such performance ratings are “slow”, “moderate” or “rapid” rate of dispersion; “incomplete”, “fair” or “complete” quality of dispersion, and “likely”, “possible” or “unlikely” stability of dispersion. In FIG. 4 three sprayability performance ratings are assigned to each of the three sprayability performance criteria resulting in a matrix which includes twenty-seven possible sprayability performance ratings.

Combinations of sprayability performance ratings from different sprayability performance criteria can likewise be relatively categorized into sprayability performance categories. For example, a liquid composition could be sprayability performance categorized as “good”, “a potential problem”, “a likely problem”, or “poor”. In FIG. 4, the liquid composition of Example 4 (3C) and Example 6 (6A), could be sprayability performance categorized as “good” based on their performance ratings of “rapid” dispersion, “good” rate of dispersion, and “complete” dispersion stability.

A sprayability assessment protocol can be developed which provides rules for evaluation conditions, and which allows the interpretation of the output data. The results of this assessment can be depicted as a sprayability performance pattern, obtained from using the present apparatus and/or methods, with the assignment of a rating. Such a protocol can be useful in predicting the propensity of a liquid composition, for example, a dispersible crop protection product used in agricultural sprayers, to plug screens and/or filters.

Evaluations can be performed on a wide range of liquid compositions prepared from known products, the performances of which are well known. Tests can be run under standard conditions including a common temperature, such as is described in Examples 2-4. The reproducible quantitative performance patterns can then be evaluated based on known field performance and given ratings in categories deemed most important to customers. Through time a compendium of performance patterns can be collected. Performance categories and ratings will evolve that reflect predictable performance. The output for any new sample can then be compared to sprayability performance patterns in this compendium for the same process conditions. Sprayability performance ratings and/or a sprayability performance category can then be assigned with confidence.

Interpretation of results from the present apparatus and method can differ since sprayability performance expectations for a liquid composition can differ depending on, for example, an intended market, an application rate, and/or a specific use in a market. For instance, sprayability performance expectations for an herbicide product intended for use in a cold climate can differ from those for a fungicide product or an insecticide product intended for use in a warm climate.

One embodiment of an application of the apparatus and methods of the present invention is their use in the development of new product formulations and in the evaluation of reformulations of existing products, for example crop protection products. Pilot crop protection formulations can be rapidly evaluated to determine whether or not there are likely to be potential filter screen or spray nozzle pluggage issues associated with the formulation. Likewise, this technique and apparatus can enable comparison of different product formulations and process conditions. Such evaluations, which can be conducted in a relatively short period of time, can help to decrease the time required to develop, optimize and commercialize new formulation compositions. Because a compendium of sprayability performance patterns for a particular crop protection product will continue to grow with the addition of new test data, this compendium can provide a good basis for evaluation of crop protection product formulation options and increases the likelihood that a new crop protection product formulation, which performs well in a sprayability evaluation using the apparatus and methods of the present invention, will perform well under field and equipment conditions.

The apparatus and methods of the present invention can also be used as a quality control or assurance tool in a manufacturing facility and/or as a diagnostic tool to trace the source of quality problems relating to sprayability, which may arise during production. It could also be used for optimizing process conditions. For example, product can be evaluated for its sprayability performance as it emerges from a production line. Similarly, lots, batches or drums of product can be evaluated prior to release for shipment, and products from different production facilities can be compared. The apparatus and methods of the present invention can also function as a tool for marketing to evaluate and/or compare the sprayability performance of competing products. The apparatus and methods of the present invention can also be used to assist in clarifying directions on a product label. In the agricultural field, this can include evaluation and/or recommendation for compatible tank mix partners, mixing times and/or temperatures. Since sprayability problems sometimes arise in the field, the apparatus and methods of the present invention can be used in the field to diagnose and solve such problems.

Because the design of the apparatus of this invention is versatile and the methodology can be applied to many customer uses, the apparatus and methods of the present invention can be applied to other industries besides agriculture. For instance, the apparatus and methods of this invention can be used for evaluating how well drink mixes dissolve or disperse in a liquid, e.g. chocolate milk mix into milk, or evaluating how readily and completely dietary or medicinal supplements dissolve or disperse into a liquid. Other embodiments of the filtering means can be used in an evaluation of the rate at which “leak stopping additives” for automotive cooling systems or industrial processes seal or plug a leak. With respect to the automotive industry, the apparatus and methods of the present invention can be used to indicate the amount and size of suspended solids in a coolant or in other automotive fluids.

### EXAMPLE 1

### Illustrative Sprayability Apparatus and Operation

The examples that follow use one embodiment of the present apparatus and method, as described in this first Example. With reference to FIG. 1 as a schematic diagram, this embodiment comprises the following:

Container 1 is an inverted 3 liter polyethylene terephthalate soft drink bottle. A top was fabricated from two 0.75-inch DELRIN® acetal resin (DuPont Corporation, Wilmington, Del.) sheets. The gravitational top sheet had holes cut to snugly accommodate feed line 2b, three flow conduits 17b holding each of the three filter screen assemblies 24, and rinse supply line 18. The gravitational bottom DELRIN® sheet had a large hole cut into it to accommodate the full width of container 1. The DELRIN® sheet extended to the rear to enable clamping onto a frame to provide partial physical support for container 1. Container 1 was further supported at its gravitational bottom by a female screw fitting fashioned to accept the inverted bottle screw thread and connect it to container exit valve 12. Container exit valve 12 is a 4-way stainless multiport ball valve (0.5-inch female NPT part no. SS-45YF8 (Swagelok Corporation, Solon, Ohio). One position of the ball valve feeds an Aquatec 12 VDC Demand/Delivery Pump 3, Model DDP 550 (Aquatec Water Systems, Inc., Irvine, Calif.). Pump 3 receives power from an EPSCO Model D612T Filtered DC Power Supply 4 (EPSCO, Inc., Addison, Illinois). This 4-way valve is being utilized as a 3-way valve. Unless otherwise noted, first circulation line 13a, rinsate drain line 13, temperature changing reservoir drain line 14a, and waste drain line 20 were made from 0.5-inch stainless steel tubing with a 0.8 mm wall thickness. All metal-to-metal connections were made using standard 0.25-inch stainless steel pipe and tube fittings (Swagelok Corporation, Solon, Ohio). Temperature changing reservoir 14 is a standard laboratory stainless steel bucket with a diameter of approximately 180 cm and a height of about 265 cm. Flow meter 10 is a model no. 38410 EM Flowmeter made from polyvinylchloride and Delrin® (Spraying Systems Co., Wheaton, Ill.). Second circulation line 13b feeds into flow divider 17a which is a 0.25-inch stainless steel cross with a vertical entry port which was welded on. Flow divider 17a distributes the liquid composition flow equally in three directions through flow conduits 17b. The fourth leg of the cross, flow conduit 17c, connects to a liquid filled 0-100 psi (0-690 kPa) pressure gauge 5 (Swagelok Corporation, Solon, Ohio). The three flow conduits 17b are turned down 90 degrees with standard rounded elbows each of which connect to threaded 0.25-inch inch stainless pipe. The pipe is further connected to a section of Tygon® flexible tubing using a conventional stainless steel hose clamp. The Tygon® sections serve as transparent sight sections 19 that enable observation of the liquid composition as it flows to container 1. Transparent sight sections 19 each feed through conventional connectors into another stainless steel fitting which is essentially a “tee” with an additional welded entry line to accept pressure transducer 6a at approximately a 45-degree angle with the vertical. The specific angle is not critical as long as it is acute and discourages accumulation of particulates within the liquid composition. The other entry line accommodates one filter line air bleed valve 22 which is made of PVC and is oriented vertically so that any liquid composition trapped in the line can be conveniently drained. Pressure transducers 6a and 6b are Model 209 OEM Pressure Transducers with stainless steel sensing elements (Setra Company, Roxborough, Mass.). Pressure transducers 6a and 6b each produce about 4 to about 20 milliampere output over a pressure range between about 0 and about 100 psi (about 0 to about 690 kPa) or about 0 to about 150 psi (about 0 to about 1035 kPa). Both pressure ranges are suitable since the precision of the transducers is better than 0.1% of full scale. A section of 0.25-inch stainless steel pipe feeds from the bottom of a pressure transducer fitting into the top of each filter screen assembly 24. The output of each filter screen assembly 24 connects to another fitting constructed similar to the aforementioned fitting except that it is configured as a “Y” to accommodate a single pressure transducer 6 at an acute angle with the direction of flow of the liquid composition. Pressure transducers 6a and 6b and flow meter 10 receive power from a Model 1670 DC Power Supply 21 (BK Precision Corporation, Yorba Linda, Calif.). A short section of stainless pipe extends from a “Y” fitting and through the top of container 1 further connecting to common nozzle body (Spraying Systems, Wheaton, Ill.). The nozzle body holds a hollow cone nozzle 11, Model TX-VS18 (Spraying Systems, Wheaton, Ill.). A section of Tygon® tubing is attached to each nozzle 11 and extends beneath the surface of the liquid composition thus serving as foam reduction tube 23. The three flow conduits 17b exiting from flow divider 17a and terminating in foam reduction tubes 23 are constructed substantially alike using the same materials of construction with identical pipe, tubing, fitting and nozzle sizes and orientation and differ only in the screen size openings held in filter screen assemblies 24.

FIG. 2 shows the elements for each filter screen assembly 24. Top screen assembly 15a and bottom screen assembly 15b are parts CP25607-5-NY and BJ1/4TT-NYB (Spraying Systems, Wheaton, Ill.) and comprise the parts to a typical nozzle body in an inverted position. Screens 7, 8 and 9 are parts 7630-50, 7630-100 and 7630-200 (Spraying Systems, Wheaton, Ill.) with screen openings of 50 mesh, 100 mesh and 200 mesh, respectively. Flow conduits 17b from flow divider 17a and container 1 can be constructed in a variety of ways and with various materials of construction as will be obvious to one skilled in the art. In this embodiment, the distribution of the flow into flow divider 17a is equally divided into three smooth and unobstructed flow paths and pressure transducers 6a and 6b do not possess areas that can cause solids collection or hang-up for particulates. Pressure transducer 6a and 6b are placed at the same distance above and below filter screen assemblies 24 for each flow conduit 17b. The materials of construction were resistant to the liquid composition. Pressure transducer precision was 0.1% of scale for all pressure transducers. Nozzles 11 were identical and provided a pressure and liquid velocity which produced a mild turbulent liquid flow. Flow rates from about 0.8 to about 1.1 L/minute at a line pressure of about 275 kPa were used. This design approach ensured that the only significant difference to cause pressure variation in each flow path and/or each circulation line was the manner in which the liquid composition passed through the three differently sized screens 7, 8 and 9. Signals from the six pressure transducers 6a and 6b and flowmeter 10 were input to a data collection device Model SC-2345 (National Instruments Corp., Austin, Tex.) which is not shown in FIG. 1. The output of the data collection device was sent to a laptop computer 25 using a Pentium IV processor. A Pentium II processor is also suitable. The seven data signals were converted using LabView software from National Instruments, Inc. to collect, convert and store the data as pressure and flow readings in spreadsheet form every second during most test runs.

### EXAMPLE 2

### Liquid Composition Exhibiting Slow Dispersion/Dissolution

The apparatus described in Example 1 was used in this example. A 20 gram sample of water soluble granule formulation, a mixture of two herbicides was added to and stirred in 500 mL of 0° C. water at 200 rpm for 2 minutes using a common laboratory magnetic stirring bar and magnetic stirrer. After the stirring was completed, the resulting mixture was promptly poured through feed funnel 2a that introduced the liquid composition into container 1. As the liquid composition entered container 1, pump power supply 4 was simultaneously turned on so that pump 3 began to circulate the liquid composition through first circulation line 13a which passed through temperature changing reservoir 14 filled with ice water, flow meter 10, and directly fed flow divider 17a which equally split the liquid composition into three streams. Except for a brief pressure surge at around 100 s line pressure was maintained at 138 kPa by adjusting pump power supply 4 to pump 3. The liquid composition traveled past transparent sight sections 19 and continued to flow to filter screen assemblies 24. Each of the three test streams of liquid composition flowed through its filter screen assembly 24 and passed through identical spray nozzles 11 and foam reduction tubes 23 which introduced the flowing stream below the liquid surface in container 1, thereby minimizing creation of foam in container 1. As the liquid composition passed through the three screens 7 (50 mesh), 8 (100 mesh), and 9 (200 mesh), the pressure drop across each screen 7, 8, and 9 was measured and recorded.

The data were plotted and are shown in FIG. 3A. As can be observed from the graph in FIG. 3A, the percent of the line pressure drop due to the 50-mesh screen, the 100-mesh screen, and the 200-mesh screen all rose within about the first 25 s to nearly 100%. This indicated that all three screens were substantially or completely plugged. At about 100 s, the 50-mesh screen began to permit some flow and by approximately 200 s there was no significant pressure drop across the 50-mesh screen. This indicated that there was no appreciable blockage of the 50-mesh screen. A similar sprayability performance pattern could be observed for both the 100-mesh screen and the 200-mesh screen but they released pressure more slowly. By about 300 s, the liquid composition freely passed through all three filters and by the end of the test, it was apparent that all or substantially all of the particulates had disappeared from all of the screens based on the fact that there was no longer any appreciable pressure drop across any of them. Based on a sprayability assessment protocol, the sprayability performance pattern shown in FIG. 3A generated sprayability performance ratings of “slow” rate of dispersion, “complete” dispersion, and an “unlikely” tendency to reagglomerate.

### EXAMPLE 3

### Liquid Composition Exhibiting Reagglomeration

The apparatus described in Example 1 and the procedure described in Example 2 were used in this example. A granular mixture of two herbicides was tested at 20° C. for 900 s. FIG. 3B is a graph representing the data generated from this test which shows the screen with the finest openings (75 microns or 200 mesh) carried nearly 100% of the pressure drop in its line for the full 900 s of the test, while the other two filters with larger openings carried almost no pressure drop from the start. As time passed, both filters with the larger openings began to rebuild some pressure, which increased with time. Based on a sprayability assessment protocol, the sprayability performance pattern shown in FIG. 3B generated sprayability performance ratings of “rapid” rate of dispersion, “complete” dispersion, and “likely” tendency to reagglomerate.

### EXAMPLE 4

### Liquid Composition Exhibiting Rapid Dispersion/Dissolution

The apparatus described in Example 1 and the procedure described in Example 2 were used in this example. A soluble granular herbicide formulation, was tested at 0° C. for 900 s. FIG. 3C is a graph representing the data generated from this test which shows that from the outset none of the three filters caused any appreciable pressure drop and continued so for the full test length, indicating that none of the filters experienced blockage. Based on a sprayability assessment protocol, the sprayability performance pattern shown in FIG. 3C generated sprayability performance ratings of “rapid” rate of dispersion, “complete” dispersion, and “unlikely” tendency to reagglomerate.

Points 3A, 3B and 3C in FIG. 4 show the relative sprayability performance ratings of the liquid compositions tested in Examples 2, 3 and 4 with respect to the sprayability performance criteria of rate, completeness and stability of dispersion.

### EXAMPLE 5

### Reproducibility of Sprayability Performance Patterns

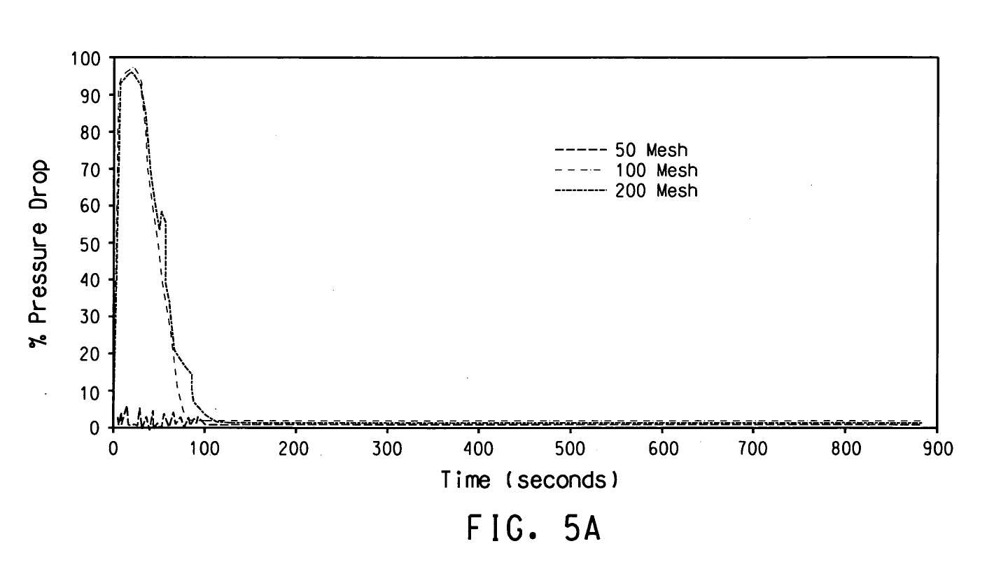

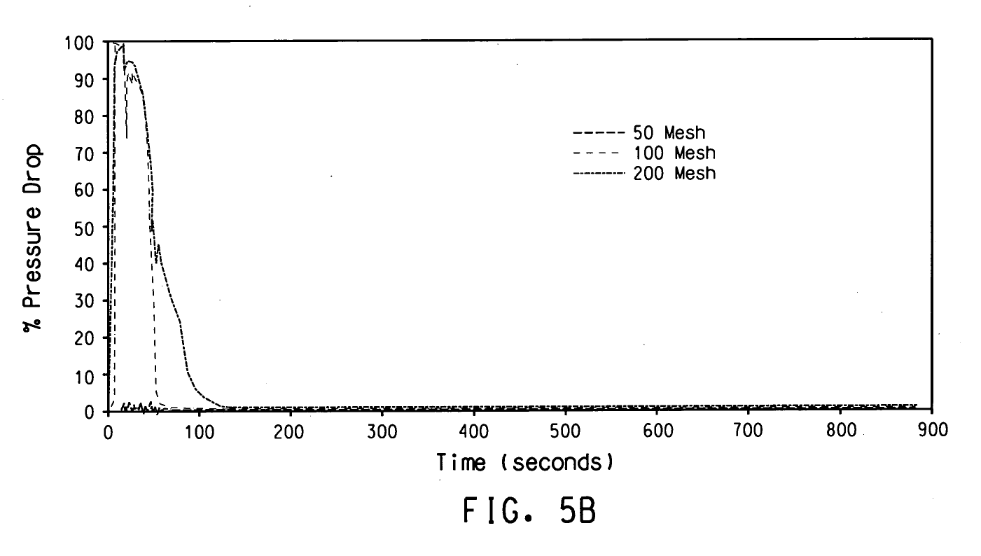

The apparatus of Example 1 and the procedure of Example 2 were used in this example. Two samples from the same batch of a standard granular placebo formulation, were evaluated at 0° C. The first test, the results of which are shown in FIG. 5A, was conducted on one day. The second test, the results of which are shown in FIG. 5B, was conducted about 10 weeks later.

As can be observed from the graphs in both FIG. 5A and FIG. 5B, the percent pressure drop across the 50-mesh screen rose only slightly to about one percent and by about 50 s had dropped to about zero. The readings for the 100-mesh screen, and the 200-mesh screen rose quickly to between about 90 and about 100%. This result indicated that these two screens were almost completely plugged with particulates. At between about 50 and about 70 s, the pressure drop across the 100-mesh screen fell rapidly to about zero. This observation indicated that the particulates that were collected on the 100-mesh screen had wholly dissolved or had partially dissolved to a size small enough to freely pass through that screen. A similar pattern could be observed for the 200-mesh screen which shows that between about 100 to about 110 s the particles on that screen had all fully dissolved or had partially dissolved to a size small enough to freely pass through that screen. By the end of the test, it was apparent that all or substantially all of the particulates from the liquid composition had disappeared from all of the screens based on the fact that there was no appreciable pressure drop across any of the screens.

Although the tests were conducted at different points in time, the sprayability performance patterns are essentially the same indicating that the apparatus and method of the present invention produced reproducible sprayability patterns for the same sample. It is clear that unless the apparatus includes pressure transducers with the requisite accuracy, precision and speed and unless the data is captured real-time, it is not possible to demonstrate result reproducibility. Additionally the procedure described in Example 2 must be closely followed so that the test conditions yields reproducible performance for the same sample tested at different times.

Points 5A and 5B in FIG. 4 show the relative sprayability performance ratings of the liquid compositions tested in Example 5 with respect to the sprayability performance criteria of rate, completeness and stability of dispersion.

### EXAMPLE 6

### Evaluation of Manufacturing Consistency

The apparatus described in Example 1 and the test procedure described in Example 2 were used for the evaluation of both samples used in this example. Both evaluations were conducted at 0° C. A water-soluble granule formulation of a herbicide (produced at a manufacturing facility) was used in the first test in this series. The second test in this series was conducted using a sample taken from a second batch of the same formulation that was produced in a small-scale semiworks facility using the same starting ingredients.

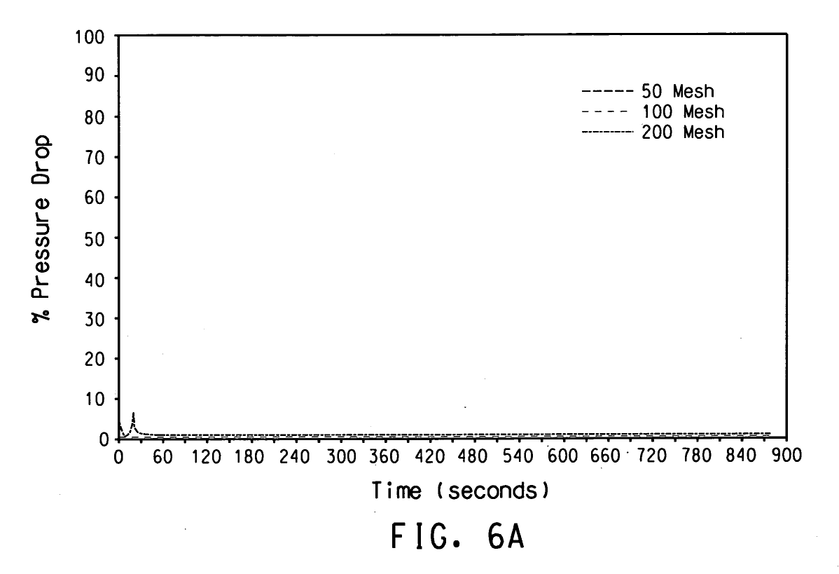

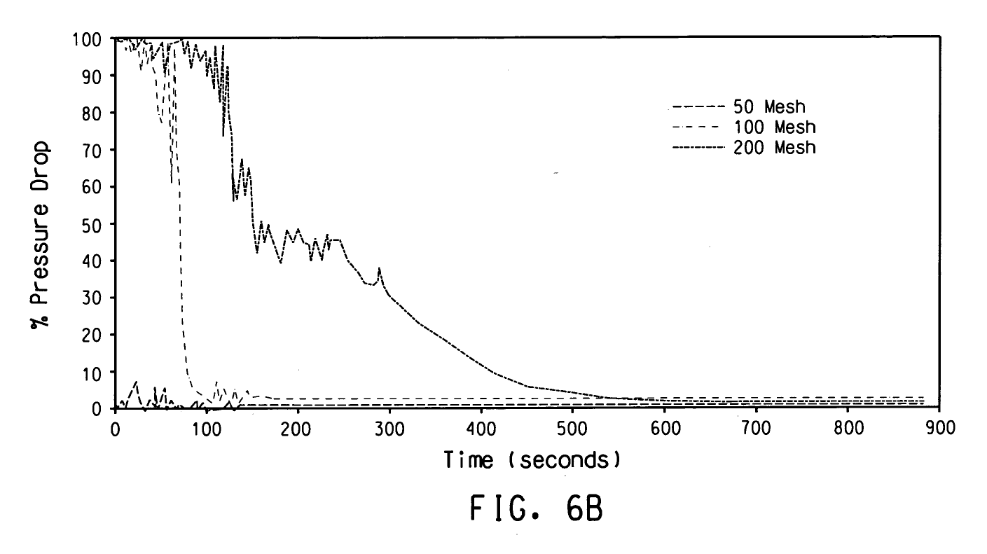

The results of the first test-are shown in FIG. 6A. As can be seen, there was no appreciable percent pressure drop attributable to any of the three screens during the evaluation. As shown in FIG. 4 (Point 6A), the sprayability performance ratings generated from the sprayability performance patterns of this test with regard to the rate, stability, and completeness of dispersion were “rapid”, “complete” and “good”, respectively. Such ratings generated a sprayability performance category of “good” (on a scale of “good”, “fair” and “poor”), and thus the liquid composition of Test C would likely be suitable for use in an agricultural sprayer in the field.

It can be seen from FIG. 6B that a problem existed with the liquid composition used in the second test. The data for the 50-mesh screen showed some percent pressure drop indicative of minor clogging from the beginning of the test until about 70 s. After about 70 s the percent pressure drop decreased indicating that the particulates that had collected on the screen had completely dissolved or had partially dissolved to a size small enough to freely pass through that screen. The data for the 100-mesh screen showed the screen to be substantially or completely clogged with particulates until about 80 s, when it rapidly cleared, and all of the particulates had partially or completely dissolved by about 120 s. The data for the 200-mesh screen showed that screen was substantially or completely clogged until about 120 s, after which time the flow was less restrictive until all or substantially all of the particulates had dissolved by about 600 s. Based on the sprayability performance patterns generated and the associated ratings of “slow to moderate” for rate of dispersion, “complete” for completion of dispersion, and “good” for stability of dispersion, as shown in FIG. 4 (Point 6B) the liquid composition used in this second test would be assigned to a “poor” sprayability performance category and would be expected to cause sprayability problems in the field.

The startling difference in sprayability performance patterns between the two liquid compositions presumably produced in the same manner using the same starting materials resulted in an investigation as to the cause of the change in speed of dissolution for the liquid composition used in the second test. Upon examining the process conditions under which the particulates of the liquid composition used in the second test were prepared, it was learned that they had been dried at a higher temperature than particulates of the liquid composition used in the first test. Thus production operation specifications were adjusted to specify drying temperature to avoid recurrence of the problem.

Points 6A and 6B of FIG. 4 also show the relative sprayability performance ratings of the liquid compositions tested in Example 6 with respect to the sprayability performance criteria of rate, completeness and stability of dispersion.

What is claimed is:

1. An apparatus for evaluating the sprayability of a liquid composition, comprising:
(a) a container having container inlet means for receiving a liquid composition and container outlet means for dispensing the liquid composition;
(b) a pump for circulating the liquid composition through the apparatus;
(c) a first means for providing fluid communication between the container and the pump;
(d) optional means for changing the temperature of the liquid composition;
(e) at least one flow conduit, said flow conduit being disposed downstream of and in fluid communication with a second fluid communication means, said flow conduit extending into the container, said second fluid communication means providing fluid communication between the pump and the flow conduit;
(f) optional means for dividing the flow of the liquid composition into at least two streams, said optional flow dividing means being disposed between the second fluid communication means and each of the flow conduits;
(g) means for filtering the liquid composition having a filter inlet means and a filter outlet means, said filtering means being disposed within each of the flow conduits, said filtering means having different filtering characteristics when more than one flow conduit is employed;
(h) first means for measuring pressure of the liquid composition in each flow conduit, said first pressure measuring means being disposed upstream of and in close proximity to the filter inlet means of the filtering means;
(i) second means for measuring pressure of the liquid composition in each flow conduit, said second pressure measuring means being disposed downstream of and in close proximity to the filter outlet means of the filtering means;
(j) means for restricting the flow of the liquid composition as it exits each flow conduit, said spraying means being disposed downstream of the second pressure measuring means; and
(k) optional means for reducing foaming of the liquid composition disposed downstream of the spraying means at or near a terminal end of each flow conduit.

2. The apparatus of claim 1 wherein the flow dividing means comprises a flow divider which separates the liquid composition into three streams.

3. The apparatus of claim 2 wherein the filtering means comprises a screen.

4. The apparatus of claim 3 wherein the screen within each flow conduit has a different mesh size.

5. The apparatus of claim 1 wherein both the first and second pressure measuring means comprises a pressure transducer.

6. The apparatus of claim 1 wherein the temperature changing means is present and is used to lower the temperature of the liquid composition.

7. A method for evaluating the sprayability of a liquid composition, comprising:
(a) introducing a liquid composition into the apparatus of any of claims 1-6;
(b) supplying power to the apparatus;
(c) circulating the liquid composition through the apparatus for a sufficient period of time;
(d) collecting pressure measurements from paired first and second pressure measuring means in each flow conduit at specified intervals during the time period;
(e) calculating the difference in pressure or percent of decrease in pressure of the liquid composition between each paired first and second pressure measuring means at each specified time internal;
(f) comparing data generated from the calculations; and
(g) optionally comparing the data with a compendium of previously obtained data, said data having been obtained using a common method protocol.

8. The method of claim 7 wherein the specified interval ranges from 1 to 5 seconds.

9. The method of claim 7 wherein the data is graphed to show the percent of pressure drop in each flow conduit over time.

10. The method of claim 7 wherein the liquid composition comprises a biologically active compound or agent.
